(19) United States
(12) Patent Application Publication
(10) Pub. No.: US 2025/0045952 A1
(43) Pub. Date: Feb. 6, 2025

(54) REAL-TIME MULTIPLE VIEW MAP GENERATION USING NEURAL NETWORKS

(71) Applicant: NVIDIA Corporation, Santa Clara, CA (US)

(72) Inventors: Alexander Popov, Kirkland, WA (US); Nikolai Smolyanskiy, Seattle, WA (US); Ruchita Bhargava, Redmond, WA (US); Ibrahim Eden, Redmond, WA (US); Amala Sanjay Deshmukh, Redmond, WA (US); Ryan Oldja, Issaquah, WA (US); Ke Chen, Mountain View, CA (US); Sai Krishnan Chandrasekar, Santa Clara, CA (US); Minwoo Park, Santa Clara, CA (US)

(73) Assignee: NVIDIA Corporation, Santa Clara, CA (US)

(21) Appl. No.: 18/363,265

(22) Filed: Aug. 1, 2023

(51) Int. Cl. G06T 7/73

(52) U.S. Cl. CPC G06T 7/74; G06T 2207/20081; G06T 2207/20084

(57) ABSTRACT

In various examples, systems and methods are disclosed relating to real-time multiview map generation using neural networks. A system can receive sensors images of an environment, such as images from one or more camera, RADAR, LIDAR, and/or ultrasound sensors. The system can process the sensor images using one or more neural networks, such as neural networks implementing attention structures, to detect features in the environment such as lane lines, lane dividers, wait lines, or boundaries. The system can represent the features in various views, including top-down/bird's eye view representations. The system can provide the representations for operations including map generation, map updating, perception, and object detection.

### BACKGROUND

Machine learning models, such as neural networks, can be used to process image data from cameras and other sensors in order to detect objects or other features in environments. This can be performed, for example, to determine a map of an environment. However, such approaches may lack realism or quality, including when used for real time map generation.

### SUMMARY

Embodiments of the present disclosure relate to systems and methods for generating three-dimensional (3D) map data using neural networks, including neural networks that have transformer architectures. For example, the systems can process multiple images to incorporate depth information into the image processing pipeline, and can use various attention modules to enable 3D information regarding features to be efficiently detected and mapped to various frames of reference, such as a top-down/bird's eye view frame of reference. As compared with conventional systems, such as those described above, systems and methods in accordance with the present disclosure can allow for more realistic, higher quality generation of maps or other representations of features, and can allow for such aspects with greater computational efficiency.

At least one aspect relates to a processor. The processor can include one or more circuits to receive a first sensor image detected at a first time point and a second sensor image detected at a second time point. The one or more circuits can determine, using a neural network and based at least on the first sensor image and the second sensor image, one or more features represented by the first sensor image and the second sensor image. The one or more circuits can determine, using the neural network, a grid of the scene in which the one or more features are respectively assigned to a cell of the grid. The one or more circuits can at least one of (i) assign the grid to a map data structure or (ii) present the grid using a display device.

In some implementations, the one or more circuits can determine the one or more features using at least one of radio detection and ranging (RADAR) data, light detection and ranging (LIDAR) data, or ultrasound data corresponding to at least one of the first sensor image or the second sensor image. In some implementations, the grid includes a two-dimensional representation of the scene in a top-down frame of reference. In some implementations, the one or more circuits can determine, for each feature of the one or more features, a polyline representing the feature. The polyline can include a plurality of points indicating a plurality of line segments. The one or more circuits can assign the feature to the cell by assigning the polyline to the cell.

In some implementations, the one or more circuits can provide, as input to the neural network, a position representation of at least one of a camera center of the first sensor image, a camera center of the second sensor image, a vector of a ray to a feature of the first sensor image, or a vector of a ray to a feature of the second sensor image. In some implementations, the one or more circuits can include a featurizer to convert image data of the first sensor image and the second sensor image into a plurality of tokens in a latent data space. In some implementations, the one or more circuits can include an encoder cross-attention processor to process the plurality of tokens and a latent data representation maintained by one or more self-attention modules. In some implementations, the one or more circuits can include a decoder cross-attention processor to process an intermediate output of the neural network and the latent data representation to determine the grid of the scene.

In some implementations, the one or more circuits can assign at least one of a height of the feature or a class of the feature to the cell. In some implementations, the first sensor image and the second sensor image can include camera data.

At least one aspect relates to a processor. The processor can include one or more circuits to receive training data including a first sensor image detected at a first time point and a second sensor image detected at a second time point, at least one feature assigned to the first sensor image and to the second image. The one or more circuits can determine, using at least one neural network and based at least on the first sensor image and the second sensor image, an estimated output indicating at least one position of at least one estimated feature. The one or more circuits can update the at least one neural network based at least on the estimated output and the at least one feature.

In some implementations, the first sensor image and the second sensor image include at least one of camera data, RADAR data, LIDAR data, or ultrasound data. In some implementations, the at least one feature comprises at least one of a lane line, a lane divider, a wait line, or a boundary structure. In some implementations, the at least one neural network includes an encoder attention network, a plurality of latent space attention networks, and a decoder attention network.

At least one aspect relates to a method. The method can include receiving, using one or more processors, a first sensor image detected at a first time point and a second sensor image detected at a second time point. The method can include determining, using the one or more processors and a neural network, and based at least on the first sensor image and the second sensor image, one or more features represented by the first sensor image and the second sensor image. The method can include determining, using the one or more processors and the neural network, a grid of the scene in which the one or more features are respectively assigned to a cell of the grid. The method can include at least one of (i) assigning, using the one or more processors, the grid to a map data structure or (ii) presenting, using the one or more processors and a display device, the grid.

In some implementations, the method includes determining, using the one or more processors, the one or more features using at least one of RADAR data, LIDAR data, or ultrasound data corresponding to at least one of the first sensor image or the second sensor image. In some implementations, the method includes providing, using the one or more processors, as input to the neural network, a position representation of at least one of a camera center of the first sensor image, a camera center of the second sensor image, a vector of a ray to a feature of the first sensor image, or a vector of a ray to a feature of the second sensor image.

In some implementations, the neural network includes a featurizer to convert image data of the first sensor image and the second sensor image into a plurality of tokens in a latent data space, an encoder cross-attention processor to process the plurality of tokens and a latent data representation maintained by one or more self-attention modules, and a decoder cross-attention processor to process an intermediate output of the neural network and the latent data representation to determine the grid of the scene.

In some implementations, the grid includes a two-dimensional representation of the scene in a top-down frame of reference. The method can include determining, using the one or more processors, for each feature of the one or more features, a polyline representing the feature. The polyline can include a plurality of points indicating a plurality of line segments, wherein the one or more circuits are to assign the feature to the cell by assigning the polyline to the cell.

In some implementations, the method includes assigning, using the one or more processors at least one of a height of the feature or a class of the feature to the cell. In some implementations, the first sensor image and the second sensor image include camera data.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for real-time multiview map generation using neural networks are described in detail below with reference to the attached drawing figures, wherein:

FIG. 1 is a block diagram of an example system for real-time multiple view (multiview) map generation using neural networks, in accordance with some embodiments of the present disclosure;

FIG. 2 is a schematic diagram of an example 3D map representation of an environment that can be generated by the example system of FIG. 1, in accordance with some embodiments of the present disclosure;

FIG. 3 is a flow diagram of an example of a method for real-time multiview map generation, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to systems and methods for generating three-dimensional (3D) map data using neural networks, including neural networks that for instance have transformer architectures. The systems and methods can be implemented to allow for temporal, real-time, multiple view (multiview) map generation, as well as to determine high definition maps for downstream usage such as perception tasks, or to perform dynamic object detection. The systems and methods can be implemented to allow for more realistic and higher quality feature detection and representation, including by incorporating depth information to avoid relying on a flat world assumption regarding the shapes, extents, and/or locations of 3D objects in image-based representations.

Some systems can process image data from cameras and other sensors, such as RADAR or LIDAR, to detect features in an environment. For example, image data can be processed to detect features useful for vehicles, such as lane dividers, road boundaries, wait lines, traffic signs, etc. Such approaches may rely on detecting features in the camera frame data (e.g., two-dimensional (2D) image data), and then projecting the features into 3D using various assumptions about relationships between 2D and 3D representations of the features. However, such approaches may lack quality, realism, and/or the ability to be performed in real-time, such as for real-time image processing for use by a vehicle sensor system/autonomous vehicle controller. In addition, such approaches may require fine-tuned post-processing, which can increase latency or otherwise make computations more complex.

Systems and methods in accordance with the present disclosure can use neural networks configured to detect features of environments from camera and other sensor data. The neural networks can include an encoder cross-attention module/processor to relate input data with latent data (e.g., information retained in memory by the network), such as to enable the neural network to select tokens of interest (tokens can represent portions of image data, such as after featurization). The neural networks can include one or more self-attention modules to detect relationships amongst tokens. The neural networks can include a decoder cross-attention module/processor to query the neural networks for outputs to enable the neural networks to learn feature locations for generating a final output data structure.

For example, the system can process multiple images at different points in time to detect depth information; the system may also process other sensor data, such as RADAR/LIDAR/ultrasound data, to detect depth and other information regarding features. Image/sensor data can be featurized to reduce noise and processing requirements (e.g., by reducing numbers of tokens of image data for further processing).

Inductive priors such as camera positions and ray vectors can be assigned or added to the input image frames (e.g., subsequent to being featurized by a convolutional neural network), which can enable the model to triangulate features across images. The system can learn the positions of features (e.g., rather than determining positions in pixel space or a latent feature space) by allowing the system to process image data without assigning position/coordinate information to tokens of image data; intermediate outputs can be queried to facilitate the position detection process. For example, the system can learn positional encodings so the system can associate/correlate tokens from different sensor streams or image frames. Various inputs and/or inductive priors, such as position data, can be encoded using FFT (sin/cos) encoding.

The system can determine outputs that include representations of the features in the environment. For example, lane lines and other features can be represented as polylines, which can include one or more vertices (e.g., Bezier curve points/control points) that can represent one or more line segments to represent a shape of the features. The representations can be determined in various frames of reference, such as a top down/bird's eye. For example, the representations can be determined in a grid data structure in which polylines are assigned to cell(s) (e.g., anchors) of the grid, such as to be assigned to a cell closest to a center of the polyline (assigning the polyline to a single cell can reduce processing requirements and also enable the system to be aware of portions of the polylines that might otherwise be occluded, and further enable the data representation in the cell to regress a full representation of the feature throughout the scene). The system can encode a confidence with respect to whether the cell has a polyline assigned (during training, the confidence can be set to 100 percent since the data represents ground truth). The system can encode a class of the feature in the cell. The system can also output depth information, such as by identifying or outputting inferred inverse disparities that can be converted to depth information.

The systems and methods described herein may be used for a variety of purposes, by way of example and without limitation, for synthetic data and map generation, machine control, machine locomotion, machine driving, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as systems for performing synthetic data generation operations, automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems implemented at least partially in a data center, systems for performing conversational AI operations, systems for performing light transport simulation, systems for performing collaborative content creation for 3D assets, systems implemented at least partially using cloud computing resources, and/or other types of systems.

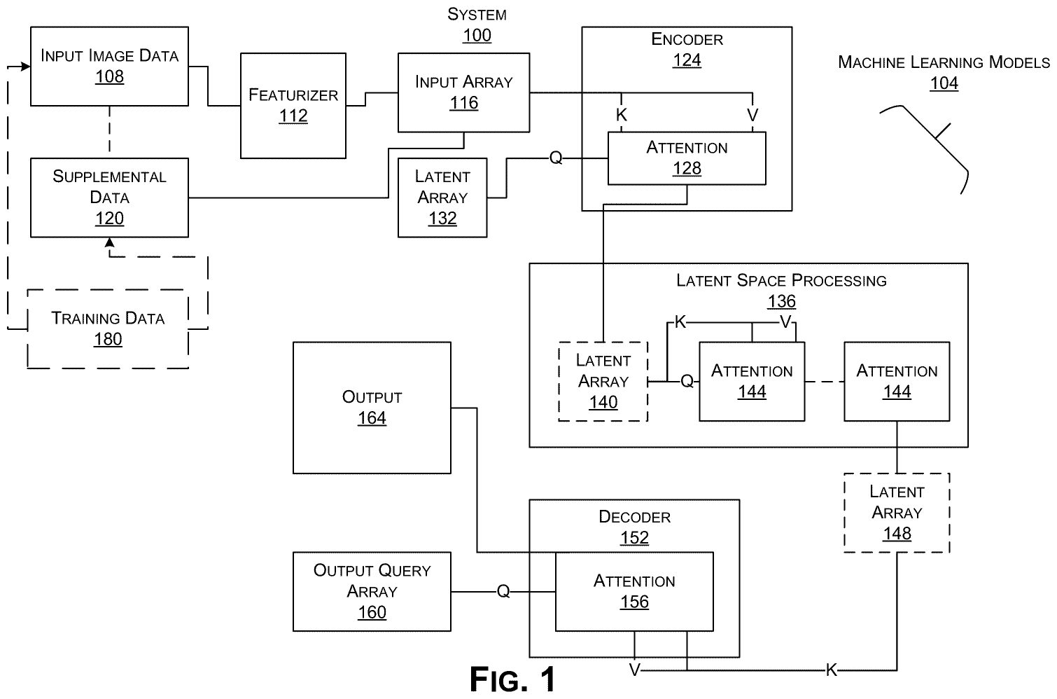

FIG. 1 is an example computing environment including a system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine learning model), operation, routine, logic, or instructions to perform functions such as configuring machine learning models 104 as described herein, such as to configure machine learning models to operate as transformer-based models, attention-based models, or various combinations thereof, including for 3D map generation.

In some implementations, the system 100 performs operations in a 3D frame of reference. The 3D frame of reference can be a frame of reference of a sensor (e.g. sensor used to detect image data 108) or a platform to which the sensor is coupled, such as a rig or vehicle. For example, the 3D frame of reference can be an X-Y-Z coordinate frame of reference in which (positive) X corresponds to a forward direction, (positive) Y corresponds to a left direction, and (positive) Z corresponds to a Z direction.

The system 100 can train, update, or configure one or more models 104. The models 104 can include machine learning models or other models that can generate target outputs based on various types of inputs. The models 104 may include one or more neural networks. The neural network(s) can include an input layer, an output layer, and/or one or more intermediate layers, such as hidden layers, which can each have respective nodes. The system 100 can train/update the neural network by modifying or updating one or more parameters, such as weights and/or biases, of various nodes of the neural network responsive to evaluating estimated outputs of the neural network.

The models 104 can be or include various neural network models, including models that are effective/implemented for operating on or generating data including but not limited to image data, video data, text data, speech data, audio data, or various combinations thereof. The models 104 can include one or more transformers, detection transformers (DETRs), deep neural networks (DNNs), convolutional neural networks (CNNs), recurrent neural networks (RNNs), long short-term memory (LSTM) models, other network types, or various combinations thereof. The models 104 can include generative models, such as generative adversarial networks (GANs), Markov decision processes, variational autoencoders (VAEs), Bayesian networks, transformer models, perceiver models, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof. As described further herein, the models 104 can include neural networks models including but not limited to featurizer 112, encoder 124, attention processors 128, 144, decoder 152, and/or attention processor 156.

The system 100 can perform operations on image data 108, which can include various forms of image-based sensor data. The image data 108 can include, for example and without limitation, camera data, ultrasound sensor data, LIDAR data, RADAR data, or various combinations thereof. The image data 108 can be retrieved from any of various databases or sensors (e.g., LIDAR sensors, RADAR sensors, ultrasound sensors, cameras, image capture devices, etc.). For example, the image data 108 can be retrieved from sensors, or can be retrieved from one or more databases in which image data are stored subsequent to detection. The image data 108 can be retrieved from sensors coupled with vehicles, such as autonomous vehicles.

In some implementations, the image data 108 can include images (e.g., sensor images) of multiple views and/or multiple time points. For example, the image data 108 can include a plurality of images from multiple poses, such as from multiple sensors coupled at different locations to a vehicle. The poses of the images can correspond to an origin and direction (e.g., perspective) of the images. This can include, for example and without limitation, front, left, and right poses of sensors on a vehicle. The images from multiple poses can be detected at the same or different time points. The image data 108 can include images detected at multiple points in time for each of one or more respective sensors and/or poses. For example, the image data 108 can include one or more of a first sensor image of (e.g., detected from) a first pose at a first time point, a second sensor image of a second pose at the first time point, a third sensor image of a third pose at the first time point, a fourth sensor image of the first pose at a second time point, a fifth sensor image of the second pose at the second time point, a sixth sensor image of the third pose at the second time point, etc.

The image data 108 can include RADAR and/or LIDAR data from the same or different poses and same or different time points as images from cameras. The RADAR or LIDAR data can include top-down perspective view data or bird's eye view (BEV) data. In some implementations, the image data 108 includes camera image frames from a front camera (e.g., 120 degree field of view), side left, side right, rear left, and rear right (e.g., 200 degree field of view) cameras, such as to include 6 frames at each time step (e.g., at time T, time T+1, etc.); for example, the camera data of image data 108 can be from the same or different perspectives than the RADAR or LIDAR data of image data 108.

The image data 108 can have information regarding the sensor(s) that detected the images assigned to the image data 108. For example, the image data 108 can include information such as a center of the sensors (e.g., camera center) or a direction of the sensors (e.g., camera ray vector) that detected the images assigned to the images. As described further herein, this can enable the system 100 to configure the models 104 to learn position information regarding features (e.g., as opposed to directly relying on position information in the images 108).

The system 100 can include at least one featurizer 112 (e.g., featurizer processor). The featurizer 112 can include one or more instructions, rules, heuristics, models, policies, functions, algorithms, etc., to perform operations including identifying features (e.g., representations of objects or other structures in the environment) from image data 108. The featurizer 112 can include a neural network, such as a CNN. The featurizer 112 can process the image data 108 to generate a modified representation of the image data 108, such as input array 116. The input array 116 can include a plurality of tokens, each token indicative of a respective feature represented in the image data 108.

The featurizer 112 can be trained using image data 108 (or images analogous to image data 108) labeled with indications of features to detect, enabling the featurizer 112 to determine the input array 116 as an image data structure indicating features. In some implementations, the featurizer 112 determines the input array 116 to have a different dimensionality (e.g., dimensions with lesser pixels per dimension) than the image data 108. The featurizer 112 can process the image data 108 to determine a plurality of tokens representative of features of the image data 108. In some implementations, the featurizer 112 can downsample the image data 108 to determine the input array 116. For example, the image data 108 can have a first size in pixel space (e.g., 960×480 pixels), and the input array 116 can have a second size less than the first size (e.g., 480×240 pixels).

In some implementations, the system 100 uses at least some different subsets of the image data 108. For example, the system 100 can use a first subset, such as a first batch, of the image data 108 to determine a first output (e.g., output 164) or intermediate outputs from image data 108, and a second subset, such as a second batch, of the image data 108 to determine a second output 164. The first subset and second subset may be from the same or different databases of image data 108, such as different databases having different levels of public accessibility. The first subset may be a training dataset, and the second subset may be a test or validation subset. The databases can include data of different types of annotations, such as annotations indicating different classes or categories of objects or features.

In some implementations, the system 100 modifies the input array 116 using one or more supplemental data 120. The supplemental data 120 can be used as priors, such as inductive priors, to allow the system 100 to learn various information associated with features represented by the image data 108; for example, the supplemental data 120 can allow the system 100 to learn locations of features (e.g., rather than directly relying location information represented by pixel locations of features in the image data 108 and/or determining the positions of features in pixel space or latent feature space; this can allow the system 100 to more effectively operate in the frame of reference of output 164). The supplemental data 120 can include camera information regarding the image data 108, such as a position of an origin or center of the image capture device that detected the image data 108, a ray vector (e.g., direction vector) representing a direction or perspective from the image capture device to the position of the image data 108, or various combinations thereof. In some implementations, the supplemental data 120 indicates directions (e.g., camera ray vectors) to respective pixels or groups of pixels of the image data 108, which can be used for positional encoding of portions of the image data 108 processed into input array 116 by featurizer 112. The supplemental data 120 can include or be retrieved from calibration data regarding the image capture devices, such as to allow the system 100 to relate the image data 108 to be in a common frame of reference. The system 100 can perform various positional encodings, such as fast Fourier transform (FFT) and/or sin/cosine encodings of the supplemental data 120. The system 100 can add the supplemental data 120 to the input array 116 and/or combine the input array 116 with the supplemental data 120, such as by concatenating the supplemental data 120 to the input array 116.

Referring further to FIG. 1, the system 100 can include at least one encoder 124, such as an encoder processor. The encoder 124 can include one or more instructions, rules, heuristics, models, neural networks, transformer neural networks, policies, functions, algorithms, etc., to perform operations including vector operations and/or applying attention and/or cross-attention to one or more inputs provided to the encoder 124. For example, the encoder 124 can perform operations including compressing or otherwise modifying the input array 116 into a latent space (e.g., from the pixel space of image data 108) for latent space processing 136.

In some implementations, the encoder 124 is or includes at least one attention processor 128. The attention processor 128 can include one or more neural networks, such as transformer neural networks, configured to perform operations such as additive attention, dot-product attention, scaled dot-product attention, or combinations thereof. As depicted in FIG. 1, the encoder 124 can receive the input array 116 as a key vector K and can receive the input array 116 as a value vector V and a latent array 132 as a query vector Q to apply as input to the attention processor 128. As noted above, the input array 116 can include an array of elements representing one or more features of the image data 108, and can be arranged in an order independent of the positioning of features in the image data 108 (and each element of the input array 116 can be encoded with position data indicated by supplemental data 120). The latent array 132 can be retrieved from the latent array 140 of latent space processing 136. In some implementations, the attention processor 128 can allow the system 100 to detect feature-like patches in the input array 116, including and without limitation lane-like patches, and to assign the feature-like patches to (vectors of) the latent array 140. By processing the input array 116 and latent array 140 using attention, the system 100 can detect attention/similarity between the vector re-representations of the feature-like patches, which can allow the system 100 to learn how features in multiple images (e.g., from different cameras or time points) are similarly represented. By determining the input array 116, in some implementations, using supplemental data 120 (e.g., positional encoding), the system 100 can allow the attention processor 128 to triangulate positions of similar/identical feature-like patches.

The machine learning models 104 can include one or more neural networks, such as attention processors 144, to perform latent space processing 136. For example, as depicted in FIG. 1, the attention processor 128 can determine, as output responsive to processing the input array 116 and latent array 132, a latent array 140. The latent array 140 (and latent array 148) can have a similar or identical structure to the latent array 132.

As depicted in FIG. 1, the latent space processing 136 can include a plurality of attention processors 144, which can be neural networks (e.g., transformer neural networks) structure similarly or identically to the attention processor 128. The attention processors 144 can be arranged in a sequence (e.g., of several attention blocks), such that the latent space output (which can have the same structure as the latent array 140) of a first attention processor 144 is provided as inputs (e.g., query Q, key K, and/or value V inputs) to a second attention processor 144 downstream from the first attention processor 144, to determine a latent array 148.

The system 100 can determine, based at least on [ ], at least one output query array 160. The output query array 160 can represent a plurality of output elements, such as output anchors. The output anchors can be arranged in top-down/BEV frame of reference. For example, the output query array 160 can be arranged in X-Y coordinates (e.g., real-world spacing of elements), with Z coordinate data (e.g., height data) assigned to respective elements. In some implementations, the output query array 160 can have a center that is offset from a center of the frame of reference of the image data 108, which can allow the processing of the information from the image data 108 to be focused or weighted towards information in front of the center of the platform having the sensor(s) that detected the image data 108.

The output anchors can represent features where one or more features intersect a respective anchor. In some implementations, the system 100, using the output query array 160, can represent features using one or more line segments, such as polyline segments. For example, the polyline segment can include at least one of a plurality of vertices or a plurality of line segments connecting respective pairs of vertices of the plurality of vertices.

Referring further to FIG. 1, the system 100 can include at least one decoder 152. The decoder 152 can include one or more instructions, rules, heuristics, models, neural networks, transformer neural networks, policies, functions, algorithms, etc., to perform operations including vector operations and/or applying attention and/or cross-attention to one or more inputs provided to the decoder 152. The decoder 152 can perform operations to determine an output 164, such as a top down perspective and/or BEV representation of the image data 108. For example, the decoder 152 can perform cross-attention between the output query array 160 and the latent array 148, which can allow the system 100 to identify features from the latent space representation of the features of the image data 108 to assign to features of using the output query array 160. In some implementations, representing the output query array 160 using output anchors that are assigned polyline segments can reduce computational requirements for determining, maintaining, and updating the output query array 160 relative to maintaining explicit BEV tensor data structures. The output 164 can be a grid having a plurality of cells at respective locations formed by the coordinates of the grid.

The system 100 can determine the output 164 to represent various features or classes of features of the environment represented by the image data 108, including, for example and without limitation, segments of lanes, road boundaries, vehicles, lines of vehicles, curbs, barriers, medians, or various other features. In some implementations, the system 100 selects a vertex of a plurality of vertices of the line segment of a given feature represented by the output query array 160 and assigns the line segment to the output query array 160 and/or the output 164 to a coordinate (e.g., X-Y coordinate) of the output query array 160 and/or the output 164 corresponding to (e.g., closest to in the X-Y coordinate space) the selected vertex. In some implementations, the system 100 selects the selected vertex as a vertex corresponding to a center, midpoint, median point, or end of the line segment. This can allow the system 100 to regress polyline segments representing features using the output anchors.

In some implementations, the system 100 performs any of various post-processing operations on the output 164 (in which features are represented as polyline segments assigned to output anchors) to determine output data. For example, the system 100 can combine one or more polyline segments or polylines into corresponding features, including but not limited to lane boundaries, wait lines, etc.

Referring further to FIG. 1, the system 100 can configured, train, or update at least a subset of the machine learning models 104 (for example and without limitation, one or more of the encoder 124, the attention processor 128, the attention processors 144, the decoder 152, or the attention processor 156) using training data 180. The training data 180 can be structured in a manner similar to or identical to the image data 108 and/or supplemental data 120. For example, the training data can include training data instances analogous to the image data 108 (e.g., camera, RADAR, LIDAR, ultrasound, etc. views of scenes) and labeled with one or more of information analogous to supplemental data (e.g., position information, poses used to detect image data, sensor origin and/or ray vector information, etc.), feature labels (e.g., indications of portions of the training data 180, such as pixels, representative of lane lines, dividers, or other features), or various combinations thereof. As such, the system 100 can use the training data 180 to supervise training, configuration, and/or updating of one or more of the machine learning models 104.

For example, the system 100 can provide one or more training data instances of the training data 180 as input to the encoder 124 (e.g., before or after processing by the featurizer 112, depending on the structure of the training data 180) to cause the encoder 124, latent array 132, latent space processing 136, decoder 152, and/or output query array 160 (and/or subcomponents thereof) to determine an estimated output. The system 100 can compare the estimated output with the respective training data instance(s) used to determine the estimated output. The system 100 can compare the estimated output with the respective training data instance(s) using any of various comparison functions, for example and without limitation objective functions or loss functions (e.g., L2 losses, L2 norms, etc.). The system 100 can use any of various optimization algorithms, such as AdamW optimization, to modify one or more weights or biases of neural network nodes of one or more machine learning models 104 according to the comparison. This can include, for example and without limitation, modifying the machine learning model(s) 104 until a convergence condition is satisfied (where the convergence condition can correspond to at least one of a threshold number of iterations or epochs of configuration or differences between the training data instances and the estimated outputs being less than a target threshold).

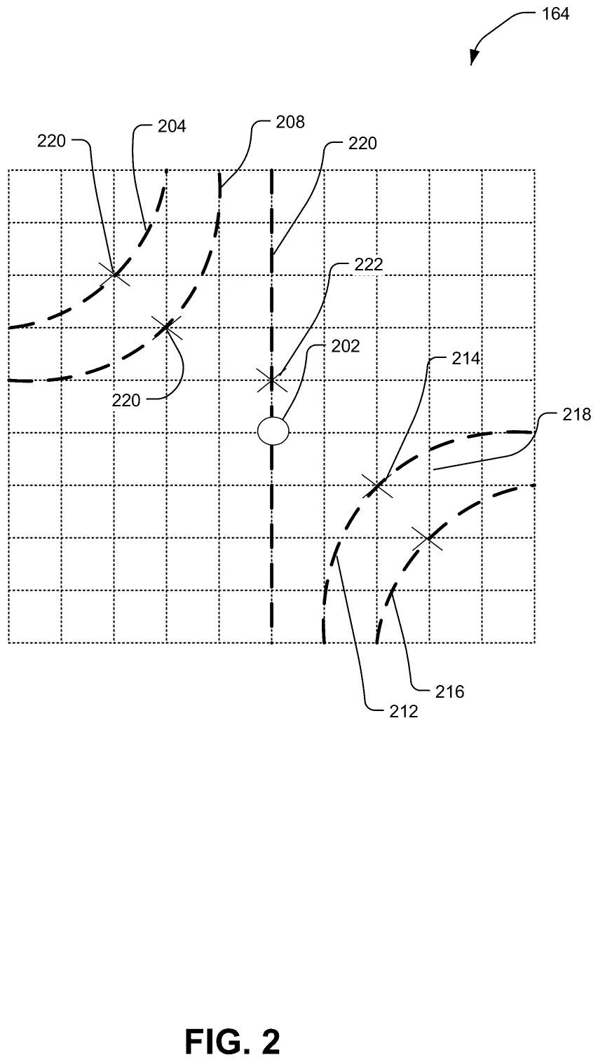

FIG. 2 depicts an example of the output 164, in accordance with some embodiments of the present disclosure. The system 100 can determine the output 164 using one or more operations described with reference to FIG. 1, including various operations of processing image data 108 and/or supplemental data 120. The system 100 can perform operations including, for example and without limitation, storing the output 164 in any of various database structures, updating the output 164 responsive to processing additional image data 108 and/or supplemental data 120, presenting the output 164 or portions thereof using any of various display devices, combining multiple outputs 164, using the output 164 to identify features in a region of a map according to a location of the region (e.g., for navigation or vehicle control operations, etc.), or various combinations thereof.

As depicted in FIG. 2, the output 160 can have a top-down/BEV perspective, extending in X and Y directions (e.g., forward/backward; left/right directions), with Z (e.g., height) position data assigned to respective features of the output 160. For example, as depicted in FIG. 2, the example output 160 represents lane lines 204, 208, 212, 216, and lane divider 220. The lane lines 204, 208, 212, 216 and lane divider 220 can be formed as polyline segments (e.g., multiple line segments connected by vertices) and can be assigned, in the data structure representing output 160, to nearest X-Y coordinates (e.g., nodes, cells, elements, positions, etc.) respective selected vertices 206, 210, 214, 218, 222 (each vertex indicating X-Y-Z coordinates). The features 204, 208, 212, 216, and 220 are depicted in dashed lines in FIG. 2 to indicate the curved representations of the feature 204, 208, 212, 216, 220 can be provided by the polyline segments assigned to respective vertices 206, 210, 214, 218, 222. For example, responsive to querying the output 160 at the location in X-Y space corresponding to vertex 206, the system 100 can identify the lane line 204, such as to identify the polyline segments forming the lane line 204 in 3D (X-Y-Z) space. As depicted in FIG. 2, the output 160 can be formed relative to an origin 202; the origin 202 can correspond to a location (e.g., ego position) of a platform, sensor, camera, vehicle, or various combinations thereof; the origin 202 can be off-center relative to the extents of the output 160 in the X and Y directions, such as to be behind a center of the output 160 relative to the forward/backward X direction.

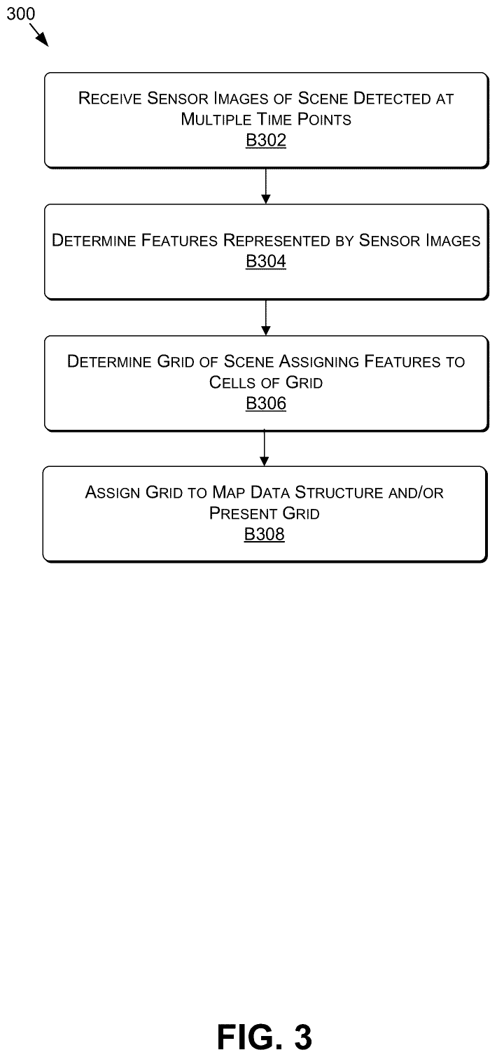

Now referring to FIG. 3, each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the systems of FIG. 1 and FIG. 2. However, this method 300 may additionally or alternatively be executed by any one system, or any combination of systems, including, but not limited to, those described herein.

FIG. 3 is a flow diagram showing a method 300 for real-time multiview map generation using neural networks, in accordance with some embodiments of the present disclosure. Various operations of the method 300 can be implemented by the same or different devices or entities at various points in time. For example, one or more first devices may implement operations relating to configuring (e.g., updating or training) attention neural networks and other machine learning models, and one or more second devices may implement operations relating to determining 3D top-down/BEV representations of environments and features in environments using image data of the environment from one or more sensors. The one or more second devices may maintain the neural networks, or may access the neural networks using, for example and without limitation, APIs provided by the one or more first devices.

The method 300, at block B302, includes receiving sensors images of a scene. The sensor images can be detected at different points in time, such as at a sequence of time points including at least a first time point and a second time point after the first time point (e.g., the time points corresponding to one or more steps of a frame rate of detection by the sensor(s)). The sensor images can be detected by the same or different sensors, such as one or more cameras, RADAR sensors, LIDAR sensors, ultrasound sensors, or combinations thereof, including from sensors arranged at different poses (e.g., positions and/or orientations); the sensors may be arranged on a platform, such as a vehicle, or on different platforms. The sensor images may be labeled with information that can be used as inductive priors, such as sensor origin, pose, and/or direction of view information. The information can indicative vectors of rays from the origin to various pixels of the sensor images, such as to facilitate positional encoding of pixels or groups of pixels. The method can include processing the sensor images to form an input array.

In some implementations, the method can include featurizing image data of the sensor images to form the input array. For example, the featurizer can be a convolutional neural network (CNN) to compress the image data into a smaller feature space, such as a latent data space, in which image data (that may be representative of features) is represented as a plurality of tokens. The tokens can correspond to image data of one or more pixels of the sensor images. The tokens can be arranged independently of positions of pixels of the sensor images, and can be assigned positional encoding information (e.g., as determined from the sensor origin, pose, and/or direction of view information).

The method 300, at block B304, includes determining features represented by the sensor images (e.g., by the input array). In some implementations, the method includes determining the features using one or more neural networks, such as attention and/or transformer neural networks. For example, the input array can be provided to an encoder cross-attention network to determine a latent representation of features of the input array, which can be provided to one or more latent space attention networks to perform attention operations on the latent representation (e.g., to identify similarities/correspondences amongst vectors of the latent representation, such as to associate features across vectors from different sensor images), which can be provided to a decoder attention network to perform attention across the latent representation and an output query array indicative of a structure of output to be determined (e.g., a grid/map representation, such as top down/BEV representation of the scene).

The method 300, at block B306, includes determining a grid of the scene that assigns detected features to cells of the grid. For example, the grid can be a top down/BEV representation of the scene, such as a representation in X-Y (forward/backward-left/right coordinates), in which Z (e.g., height) coordinate data is assigned to features. For example, the features can be represented as polyline segments, such as a plurality of line segments connected by at least one vertex, such as to represent curved features as Bezier curves using line segments. In some implementations, the method includes selecting a vertex of the at least one vertex and assigning the vertex to a cell (e.g., grid point of the grid). The vertex can be selected, for example and without limitation, as a central, median, or end vertex of the plurality of line segments. The vertex can be assigned to a nearest cell of the grid, such as a cell having a least distance in X and/or Y coordinates from the vertex. The grid can be queried to identify the features by querying the cells to retrieve any features assigned to the queried cells.

The method 300, at block B308, includes at least one of (i) assigning the grid to a map data structure or (ii) presenting/rendering/displaying, using a display device, the grid. For example, a map data structure, such as a top-down/BEV map showing the line segments forming the features, can be determined by rendering a combined representation of the line segments of each feature. Assigning the grid to the map data structure can include performing post-processing operations such as retrieving, from the grid, one or more output elements (e.g., output anchors) assigning features to cells of the grid, identifying corresponding locations in the map data structure, retrieving each of the line segments of the output elements, combining the line segments to form a curve or polyline, and assigning the curve or polyline to each pixel of the map data structure that corresponds to the curve or polyline (e.g., to form a more complete rendering of the feature in the map data structure). The map data structure can be periodically updated responsive to receiving updated sensor images. For example, responsive receiving updated sensor image data (which may correspond to updated locations in a global environment), the at least one neural network can update the grid according to the updated sensor image data.

### Example Content Streaming System

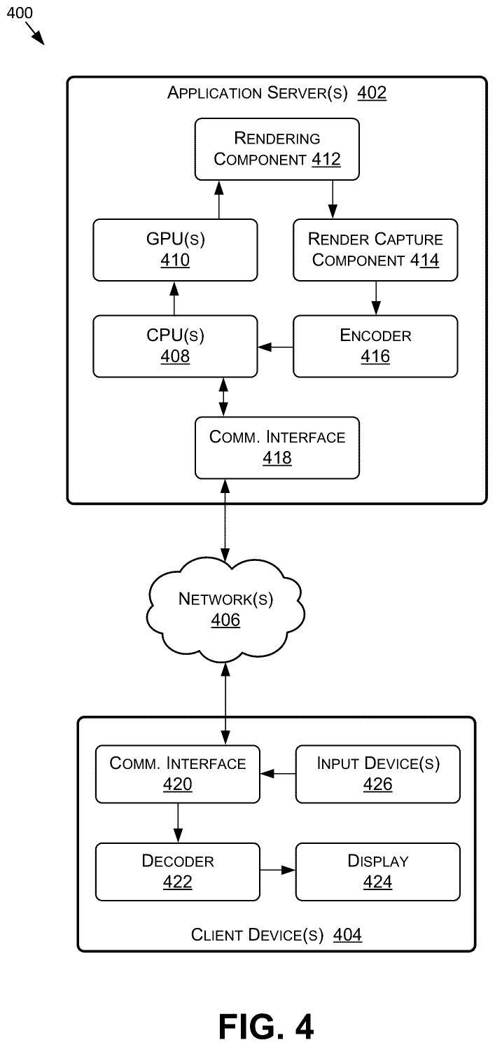

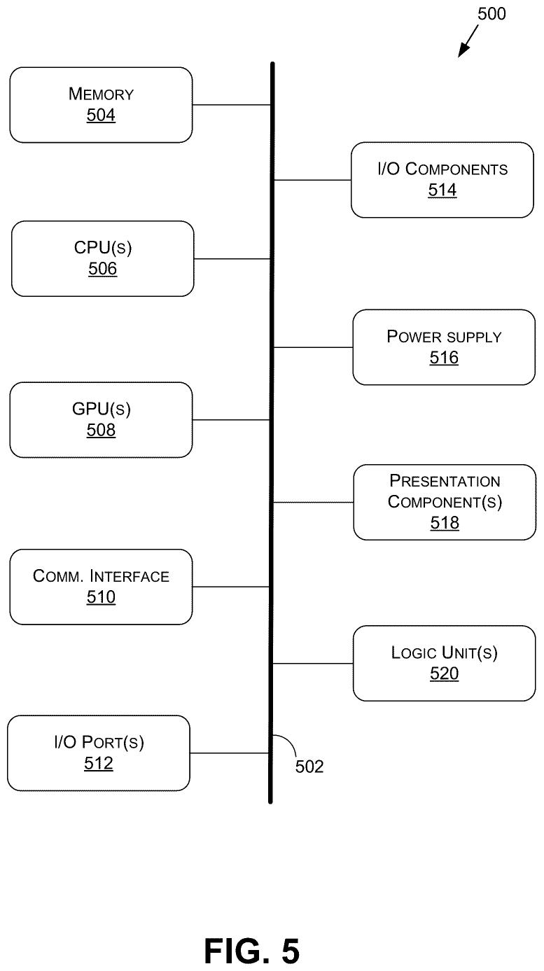

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 400 may be implemented to perform diffusion model training and runtime operations. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 400 can be implemented to receive input indicating one or more features of output to be generated using a neural network model, provide the input to the model to cause the model to generate the output, and use the output for various operations including display or simulation operations.

In the system 400, for an application session, the client device(s) 404 may only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based on receiving the display data from the application server(s) 402. The client device 404 may receive an input to one of the input device(s) and generate input data in response, such as to provide modification inputs of a driving signal for use by modifier 112. The client device 404 may transmit the input data to the application server(s) 402 via the communication interface 420 and over the network(s) 406 (e.g., the Internet), and the application server(s) 402 may receive the input data via the communication interface 418. The CPU(s) 408 may receive the input data, process the input data, and transmit data to the GPU(s) 410 that causes the GPU(s) 410 to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data) and the render capture component 414 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424, such as to display a top-down/BEV map of a scene or an environment.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may be arranged in various topologies, including but not limited to bus, star, ring, mesh, tree, or hybrid topologies. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508. In some embodiments, a plurality of computing devices 500 or components thereof, which may be similar or different to one another in various respects, can be communicatively coupled to transmit and receive data for performing various operations described herein, such as to facilitate latency reduction.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user, such as to generate a driving signal for use by modifier 112, or a reference image (e.g., images 104). In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

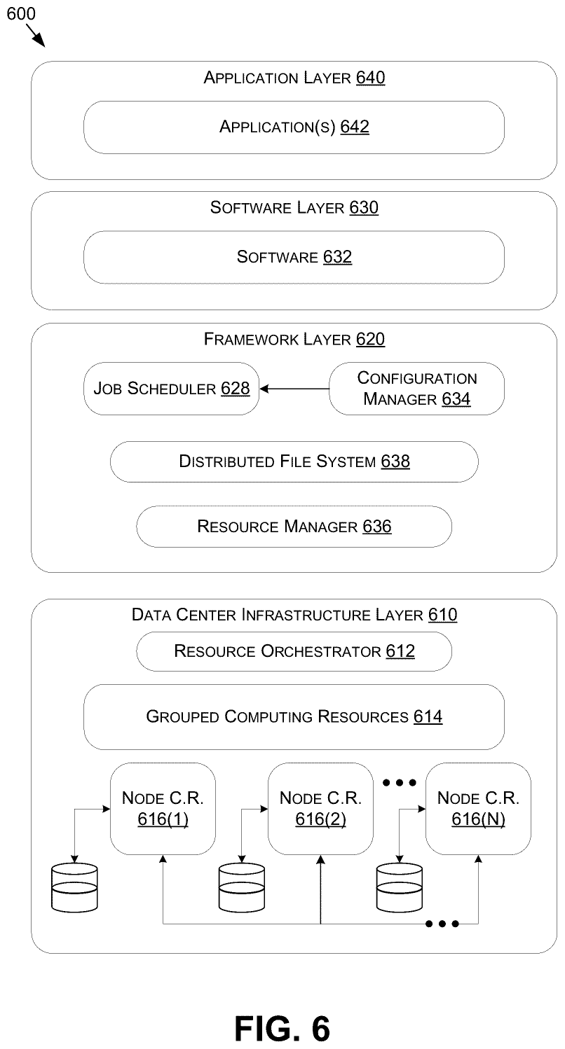

FIG. 6 illustrates an example data center 600 that may be used in at least one embodiments of the present disclosure, such as to implement the systems 100, 200 in one or more examples of the data center 600. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models 104.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models (e.g., train models 104, 204 and/or neural networks 106, 206, etc.) or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one more circuits to:
receive a first sensor image detected at a first time point and a second sensor image detected at a second time point;
determine, using a neural network and based at least on the first sensor image and the second sensor image, one or more features represented by the first sensor image and the second sensor image;
determine, using the neural network, a grid of the scene in which the one or more features are respectively assigned to a cell of the grid; and
at least one of (i) assign the grid to a map data structure or (ii) present the grid using a display device.

2. The processor of claim 1, wherein the one or more circuits are to determine the one or more features using at least one of radio detection and ranging (RADAR) data, light detection and ranging (LIDAR) data, or ultrasound data corresponding to at least one of the first sensor image or the second sensor image.

3. The processor of claim 1, wherein the one or more circuits are to provide, as input to the neural network, a position representation of at least one of a camera center of the first sensor image, a camera center of the second sensor image, a vector of a ray to a feature of the first sensor image, or a vector of a ray to a feature of the second sensor image.

4. The processor of claim 1, wherein the neural network comprises:
a featurizer to convert image data of the first sensor image and the second sensor image into a plurality of tokens in a latent data space;
an encoder cross-attention processor to process the plurality of tokens and a latent data representation maintained by one or more self-attention modules; and
a decoder cross-attention processor to process an intermediate output of the neural network and the latent data representation to determine the grid of the scene.

5. The processor of claim 1, wherein the grid comprises a two-dimensional representation of the scene in a top-down frame of reference, and the one or more circuits are to determine, for each feature of the one or more features, a polyline representing the feature, the polyline comprising a plurality of points indicating a plurality of line segments, wherein the one or more circuits are to assign the feature to the cell by assigning the polyline to the cell.

6. The processor of claim 1, wherein the one or more circuits are to assign at least one of a height of the feature or a class of the feature to the cell.

7. The processor of claim 1, wherein the first sensor image and the second sensor image comprise camera data.

8. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

9. A processor comprising:
one more circuits to:
receive training data comprising a first sensor image detected at a first time point and a second sensor image detected at a second time point, at least one feature assigned to the first sensor image and to the second image;
determine, using at least one neural network and based at least on the first sensor image and the second sensor image, an estimated output indicating at least one position of at least one estimated feature; and
update the at least one neural network based at least on the estimated output and the at least one feature.

10. The processor of claim 9, wherein the first sensor image and the second sensor image comprise at least one of camera data, radio detection and ranging (RADAR) data, light detection and ranging (LIDAR) data, or ultrasound data.

11. The processor of claim 9, wherein the at least one feature comprises at least one of a lane line, a lane divider, a wait line, or a boundary structure.

12. The processor of claim 1, wherein the at least one neural network comprises an encoder attention network, a plurality of latent space attention networks, and a decoder attention network.

13. The processor of claim 12, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

14. A method, comprising:
receiving, using one or more processors, a first sensor image detected at a first time point and a second sensor image detected at a second time point;
determining, using the one or more processors and a neural network, and based at least on the first sensor image and the second sensor image, one or more features represented by the first sensor image and the second sensor image;
determining, using the one or more processors and the neural network, a grid of the scene in which the one or more features are respectively assigned to a cell of the grid; and
at least one of (i) assigning, using the one or more processors, the grid to a map data structure or (ii) presenting, using the one or more processors and a display device, the grid.

15. The method of claim 14, further comprising determining, using the one or more processors, the one or more features using at least one of radio detection and ranging (RADAR) data, light detection and ranging (LIDAR) data, or ultrasound data corresponding to at least one of the first sensor image or the second sensor image.

16. The method of claim 14, further comprising providing, using the one or more processors, as input to the neural network, a position representation of at least one of a camera center of the first sensor image, a camera center of the second sensor image, a vector of a ray to a feature of the first sensor image, or a vector of a ray to a feature of the second sensor image.

17. The method of claim 14, wherein the neural network comprises:
a featurizer to convert image data of the first sensor image and the second sensor image into a plurality of tokens in a latent data space;
an encoder cross-attention processor to process the plurality of tokens and a latent data representation maintained by one or more self-attention modules; and
a decoder cross-attention processor to process an intermediate output of the neural network and the latent data representation to determine the grid of the scene.

18. The method of claim 14, wherein the grid comprises a two-dimensional representation of the scene in a top-down frame of reference, and the method further comprises determining, using the one or more processors, for each feature of the one or more features, a polyline representing the feature, the polyline comprising a plurality of points indicating a plurality of line segments, wherein the one or more circuits are to assign the feature to the cell by assigning the polyline to the cell.

19. The method of claim 14, further comprising assigning, using the one or more processors at least one of a height of the feature or a class of the feature to the cell.

20. The method of claim 14, wherein the first sensor image and the second sensor image comprise camera data.
